(19) United States
(12) Patent Application Publication
(10) Pub. No.: US 2009/0173242 A1
(43) Pub. Date: Jul. 9, 2009

(54) ELECTRIC PRESS APPARATUS AND DIFFERENTIAL MECHANISM

(76) Inventors: Keizo Unno, Kanagawa (JP); Shoji Futamura, Kanagawa (JP)

Correspondence Address: MCGLEW & TUTTLE, PC, P.O. BOX 9227, SCARBOROUGH STATION, SCARBOROUGH, NY, 10510-9227, US

(21) Appl. No.: 10/596,891

(22) PCT Filed: Jul. 26, 2005
(86) PCT No.: PCT/JP05/13616

§ 371 Date: Jun. 28, 2006

(51) Int. Cl. B30B 1/08; B30B 5/00

(52) U.S. Cl. 100/271; 100/257

(57) ABSTRACT

A differential mechanism 9 of an electric press apparatus having a connecting mechanism 17 fixed to a nut member 8 threadedly engaging with a ball screw shaft 15 rotated by a motor 22 and a slide plate 25 is configured so as to include a frame body 92 which has inner wall surfaces hollowed out with an opening portion being on the upside, and is formed with a slide groove at the bottom portion in inner wall surfaces, the opening portion forming a rigid body. A movable body 91 which is provided with a slide groove on the back surface side of the upper plate portion having an inclined surface portion the back surface of which is inclined, and is fitted in the opening portion of the frame body 92. A differential member 94 is provided which has a first guide engagement portion, which slidingly engages with the slide groove formed in the frame body 92, in the lower end portion, has a second guide engagement portion, which slidingly engages with the slide groove formed on the back surface side of the movable body 91, in the upper end portion, has an upper surface portion being inclined and a lower surface portion being horizontal, and has a wedge shape fitted so as to be slidable in the frame body 92. A screw shaft 95 is provided for moving the differential member 94 by means of a motor 28.

### TECHNICAL FIELD

The present invention relates to an electric press apparatus used for sheet metal working and the like, and a differential mechanism. More particularly, it relates to an electric press apparatus which withstands fixed point working requiring exact position control of micron units for a long period of time by using a mechanism for reciprocating (for example, vertically moving) a pressing element by means of ball screw engagement using a ball screw shaft driven by a motor and a nut portion thereof, and a differential mechanism.

### BACKGROUND ART

A conventional electric press apparatus in which a pressing element is moved vertically by ball screw engagement using a ball screw shaft driven by a motor and a nut portion thereof has been disclosed in Japanese Patent Laid-Open No. 2001-144098 (Patent Document 1).

FIG. 14 is a partially and longitudinally sectioned front view of a conventional electric press apparatus. In FIG. 14, reference numeral 1 denotes a base plate. The base plate 1 is formed into a rectangular flat plate shape, and columnar guide bars 2 are erected at four corners thereof. To upper end portions of the guide bars 2, a support plate 3 formed into a rectangular flat plate shape is fixed via fastening members 4. The support plate 3 is provided with a motor 22, and the main shaft of the motor 22 rotatably penetrates the support plate 3 and is connected with a screw shaft 5.

Reference numeral 25 denotes a slide plate. The slide plate 25 slidingly engages with the guide bars 2, and is provided so as to be slidable vertically. A pressing element 24 is fixed to a lower portion of the slide plate 25. Reference numeral 26 denotes a table. The table 26 is provided on the base plate 1 so that a workpiece W is mounted thereon.

A movable body 7 is formed by a first movable body 71 and a second movable body 72 which are divided by a plane crossing the travel direction of the movable body 7 (up-and-down direction in FIG. 14), for example, by the horizontal plane, and are arranged opposedly. The first movable body 71 is fixed to a nut member 8, and the second movable body 72 is fixed to the slide plate 25. Reference numeral 27 denotes a differential member. The differential member 27 is formed into a wedge shape as described later. It connects the first movable body 71 and the second movable body 72 to each other, and also has the later-described function.

Reference numeral 28 denotes a motor. The motor 28 is provided above the slide plate 25 via a support member 29 so as to drive the differential member 27 in the direction perpendicular to the travel direction of the movable body 7 (in the right-and-left direction in FIG. 14). That is to say, the motor 28 is formed so that a screw shaft 30 is connected to the main shaft of the motor 28, and the screw shaft 30 is threadedly engaged with a nut member (not shown) provided in the differential member 27. Reference numeral 36 is a guide plate. The guide plate 36 is provided in a pair on both side surfaces of the first movable body 71 and the second movable body 72, and is formed so that the lower end portion thereof is fixed to the second movable body 72, and the neighborhood of the upper end portion thereof can be engaged slidably with the first movable body 71.

FIG. 15 is an enlarged front view showing the differential member 27 and the neighborhood thereof, and FIG. 16 is a sectional view taken along the line B-B of FIG. 15. In these figures, the same reference numerals are applied to elements that are the same as those shown in FIG. 14.

In FIGS. 15 and 16, the differential member 27 is formed so that the transversely cross section has, for example, an I shape and a slope portion 37 is provided in the lengthwise direction. Protrusions 38 formed integrally in the side surface portions of the differential member 27 are provided in the first movable body 71 and the second movable body 72 and are formed so as to be capable of engaging slidably with concave grooves 39. The slope portion 37 forming the upper surface of the differential member 27 is provided in the first movable body 71, and engages slidably with a slanting surface portion 40 formed so as to have the same angle of inclination as that of the slope portion 37. Also, a bottom surface portion 58 of the differential member 27 engages slidably with a horizontal support surface 59 provided in the second movable body 72. The upper half portion of the guide plate 36 provided on the second movable body 72 via attachment members 60 engages slidably with a guide groove 61 provided in the side surface of the first movable body 71.

According to the above configuration, when a predetermined voltage is applied to the motor 22 in FIG. 14, the screw shaft 5 is rotated, so that the movable body 7 consisting of the first movable body 71, the second movable body 72, the differential member 27 that connects these movable bodies 71 and 72 to each other, and the like is lowered. Thereby, the pressing element 24 is lowered from an initial height Hₒ to a fixed point working height H, by which the workpiece W is subjected to fixed point working. After the working has been finished, the movable body 7 is raised by the reverse motion of the motor 22, and thus the pressing element 24 is returned to the position of initial height Hₒ. The measurement of the values of Hₒ and H and the control of the motor 22 are carried out by not illustrated measuring means and not illustrated control means, respectively. Such a working operation is called fixed point working.

When the above-described fixed point working reaches a preset number of cycles, or every time the fixed point working is performed, the operation of the motor 22 is stopped at the position of initial height Hₒ of the pressing element 24, and a preset number of, for example, pulse voltages are applied to the motor 28. Thereby, the motor 28 is rotated by a predetermined amount, and hence the differential member 27 is moved slightly in the horizontal direction via the screw shaft 30. By this movement of the differential member 27, the first movable body 71 and the second movable body 72 are moved relatively in the vertical direction, and the movable body 7 is displaced from the initial height Hₒ. To compensate this displacement, some voltage is applied to the motor 22, so that the initial height Hₒ of the pressing element 24 is kept constant.

By the turning of the screw shaft 5 as the result of the above-described compensation, the relative position between the screw shaft 5 and the nut member 8 is changed, so that the relative position between a ball and a ball groove, which are formed for ball screw engagement, can be changed. Therefore, local wear of the ball and/or ball groove can be prevented while the fixed point working is secured, and the fixed point working can be performed continuously after that time.
Patent Document 1: Japanese Patent Laid-Open No. 2002-144098

### DISCLOSURE OF THE INVENTION

### Problem to be Solved by the Invention

In the construction of the conventional movable body 7 consisting of the first movable body 71, the second movable body 72, the differential member 27 that connects these movable bodies 71 and 72 to each other, and the guide plates 36 as described above, especially in the connecting construction consisting of the guide plates 36 provided on the second movable body 72 so as to engage slidably with the guide grooves 61 provided in the side surface of the first movable body 71, the nut member 8 is twisted in the axial direction as the time for fixed point working is prolonged, so that there arises a problem in that the electric press apparatus cannot withstand long-term fixed point working.

Also, in order to change the above-described relative position between the screw shaft 5 and the nut member 8, and to change the relative position between the ball and the ball groove, which are formed for ball screw engagement, the differential member 27 is moved in the horizontal direction and hence the slide plate 25 is moved slightly in the vertical direction, by which the relative position between the ball and the ball groove is changed in the units of several microns, and the relative position must be kept under a condition of being changed in the units of micron during the next and subsequent cycles of fixed point working or during the predetermined cycles of fixed point working. Therefore, the vertical position of the first movable body 71 must be maintained with very high accuracy. If even a little undesirable looseness or squeak occurs, the ball groove etc. are rather broken, and the fixed point working cannot be performed.

The present invention has been made in view of the above situation, and accordingly an object thereof is to provide an electric press apparatus having a movable body capable of enabling long-term fixed point working requiring precise position control by using a differential mechanism which is a fixed point working mechanism for reciprocating a pressing element by ball screw engagement using a ball screw shaft driven by a motor and a nut member therefor, and in which no torsion is produced in any of orthogonal three-axis directions and the first movable body 71 does not loosen or squeak undesirably, and the differential mechanism.

### Means for Solving the Problem

To achieve the above object, a first electric press apparatus in accordance with the present invention comprising:
a base plate formed into a flat plate shape;
a plurality of guide bodies provided so that one end portions thereof intersect at right angles with the base plate;
a flat plate shaped support plate provided at the other end portions of the guide bodies so as to intersect at right angles with the guide bodies;
a slide plate provided so as to be slidingly moved between the base plate and the support plate by being guided by the guide bodies;
a first motor for driving the slide plate slidably with respect to the guide bodies; a ball screw shaft which is connected to the output shaft of the first motor and is pivotally supported so as to be moved in parallel with the guide bodies with respect to the support plate;
a nut member threadedly engaged with the ball screw shaft; and
a differential mechanism, the upper end of which is fixed to the nut member and the lower end of which is fixed to the slide plate, for slightly changing the contact position between the ball screw shaft and balls incorporated in the nut member,
the slide plate being moved vertically by the normal and reverse rotations of the ball screw shaft driven by the first motor, whereby a workpiece mounted on the base plate is subjected to fixed point working, and is characterized in that
the differential mechanism comprises:
a frame body in which an opening of four inner wall surfaces corresponding to an opening portion hollowed out substantially into a rectangular parallelepipedic shape is provided in the upper surface, a stripe of slide groove is provided at a bottom surface portion in inner wall surface of one set of opposed surfaces of two sets of opposed surfaces, and the rectangular parallelepipedic opening portion forms a rigid body;
a movable body which has an upper plate portion having an inclined surface portion the top surface of which is horizontal and the back surface of which is inclined, a stripe of slide groove formed on the back surface side of the upper plate portion, has a hole, which allows the ball screw shaft to pass through, in the central portion, is fitted in the opening of the frame body, and the nut member is fixed to the surface thereof;
a differential member which has a first guide engagement portion, which slidingly engages with the slide groove formed in the frame body, in the lower end portion, has a second guide engagement portion, which slidingly engages with the slide groove formed on the back surface side of the movable body, in the upper end portion, has a lower surface portion being horizontal and an upper surface portion being inclined, has a hole, which allows the ball screw shaft to pass through, in the central portion, and has a wedge shape fitted so as to be slidable in the frame body;
a screw shaft for moving the differential member in the horizontal direction; and
a second motor for moving the differential member in the horizontal direction via the screw shaft of the differential mechanism.

Also, a second electric press apparatus in accordance with the present invention comprising:
a base plate formed into a flat plate shape;
a plurality of guide bodies provided so that one end portions thereof intersect at right angles with the base plate;
a flat plate shaped support plate provided at the other end portions of the guide bodies so as to intersect at right angles with the guide bodies;
a slide plate provided so as to be slidingly moved between the base plate and the support plate by being guided by the guide bodies;
a first motor for driving the slide plate slidably with respect to the guide bodies;
a ball screw shaft which is connected to the output shaft of the first motor and is pivotally supported so as to be moved in parallel with the guide bodies with respect to the support plate;
a nut member threadedly engaged with the ball screw shaft; and
a differential mechanism, the upper end of which is fixed to the nut member and the lower end of which is fixed to the slide plate, for slightly changing the contact position between the ball screw shaft and balls incorporated in the nut member,
the slide plate being moved vertically by the normal and reverse rotations of the ball screw shaft driven by the first motor, whereby a workpiece mounted on the base plate is subjected to fixed point working, and is characterized in that the differential mechanism comprises:
a frame body in which an opening of four inner wall surfaces corresponding to an opening portion hollowed out substantially into a rectangular parallelepipedic shape is provided in the upper surface, a stripe of slide groove is provided at a bottom surface portion in inner wall surface of one set of opposed surfaces of two sets of opposed surfaces, and the rectangular parallelepipedic opening portion forms a rigid body;
a movable body which has an upper plate portion having horizontal surfaces on the top surface and the back surface thereof, a stripe of slide groove formed on the back surface side of the upper plate portion, has a hole, which allows the ball screw shaft to pass through, in the central portion, is fitted in the opening of the frame body, and the nut member is fixed to the surface thereof;
a differential member which has a first guide engagement portion, which slidingly engages with the slide groove formed in the frame body, in the lower end portion, has a second guide engagement portion, which slidingly engages with the slide groove formed on the back surface side of the movable body, in the upper end portion, has an upper surface portion being horizontal and a lower surface portion being inclined, has a hole, which allows the ball screw shaft to pass through, in the central portion, and has a wedge shape fitted so as to be slidable in the frame body;
a screw shaft for moving the differential member in the horizontal direction; and
a second motor for moving the differential member in the horizontal direction via the screw shaft of the differential mechanism.

Also, a differential mechanism of an electric press apparatus in accordance with the present invention comprising:
a base plate formed into a flat plate shape;
a plurality of guide bodies provided so that one end portions thereof intersect at right angles with the base plate;
a flat plate shaped support plate provided at the other end portions of the guide bodies so as to intersect at right angles with the guide bodies;
a slide plate provided so as to be slidingly moved between the base plate and the support plate by being guided by the guide bodies;
a first motor for driving the slide plate slidably with respect to the guide bodies;
a ball screw shaft which is connected to the output shaft of the first motor and is pivotally supported so as to be moved in parallel with the guide bodies with respect to the support plate;
a nut member threadedly engaged with the ball screw shaft; and
a differential mechanism, the upper end of which is fixed to the nut member and the lower end of which is fixed to the slide plate, for slightly changing the contact position between the ball screw shaft and balls incorporated in the nut member,
the slide plate being moved vertically by the normal and reverse rotations of the ball screw shaft driven by the first motor, whereby a workpiece mounted on the base plate is subjected to fixed point working, and is characterized in that the differential mechanism comprises:
a frame body in which an opening of four inner wall surfaces corresponding to an opening portion hollowed out substantially into a rectangular parallelepipedic shape is provided in the upper surface, a stripe of slide groove is provided at a bottom surface portion in inner wall surface of one set of opposed surfaces of two sets of opposed surfaces, and the rectangular parallelepipedic opening portion forms a rigid body;
a movable body which has an upper plate portion having an inclined surface portion the top surface of which is horizontal and the back surface of which is inclined, a stripe of slide groove formed on the back surface side of the upper plate portion, has a hole, which allows the ball screw shaft to pass through, in the central portion, is fitted in the opening of the frame body, and the nut member is fixed to the surface thereof;
a differential member which has a first guide engagement portion, which slidingly engages with the slide groove formed in the frame body, in the lower end portion, has a second guide engagement portion, which slidingly engages with the slide groove formed on the back surface side of the movable body, in the upper end portion, has a lower surface portion being horizontal and an upper surface portion being inclined, has a hole, which allows the ball screw shaft to pass through, in the central portion, and has a wedge shape fitted so as to be slidable in the frame body;
a screw shaft for moving the differential member in the horizontal direction; and
a second motor for moving the differential member in the horizontal direction via the screw shaft of the differential mechanism.

Also, another differential mechanism of an electric press apparatus in accordance with the present invention comprising:
a base plate formed into a flat plate shape;
a plurality of guide bodies provided so that one end portions thereof intersect at right angles with the base plate;
a flat plate shaped support plate provided at the other end portions of the guide bodies so as to intersect at right angles with the guide bodies;
a slide plate provided so as to be slidingly moved between the base plate and the support plate by being guided by the guide bodies;
a first motor for driving the slide plate slidably with respect to the guide bodies;
a ball screw shaft which is connected to the output shaft of the first motor and is pivotally supported so as to be moved in parallel with the guide bodies with respect to the support plate;
a nut member threadedly engaged with the ball screw shaft; and
a differential mechanism, the upper end of which is fixed to the nut member and the lower end of which is fixed to the slide plate, for slightly changing the contact position between the ball screw shaft and balls incorporated in the nut member,
the slide plate being moved vertically by the normal and reverse rotations of the ball screw shaft driven by the first motor, whereby a workpiece mounted on the base plate is subjected to fixed point working, and is characterized in that the differential mechanism comprises:
a frame body in which an opening of four inner wall surfaces corresponding to an opening portion hollowed out substantially into a rectangular parallelepipedic shape is provided in the upper surface, a stripe of slide groove is provided at a bottom surface portion in inner wall surface of one set of opposed surfaces of two sets of opposed surfaces, and the rectangular parallelepipedic opening portion forms a rigid body;
a movable body which has an upper plate portion having horizontal surfaces on the top surface and the back surface thereof, a stripe of slide groove formed on the back surface side of the upper plate portion, has a hole, which allows the ball screw shaft to pass through, in the central portion, is fitted in the opening of the frame body, and the nut member is fixed to the surface thereof;
a differential member which has a first guide engagement portion, which slidingly engages with the slide groove formed in the frame body, in the lower end portion, has a second guide engagement portion, which slidingly engages with the slide groove formed on the back surface side of the movable body, in the upper end portion, has an upper surface portion being horizontal and a lower surface portion being inclined, has a hole, which allows the ball screw shaft to pass through, in the central portion, and has a wedge shape fitted so as to be slidable in the frame body;
a screw shaft for moving the differential member in the horizontal direction; and
a second motor for moving the differential member in the horizontal direction via the screw shaft of the differential mechanism.

### Effect of the Invention

Even if a high load is applied to the movable body moved vertically via the nut member by the rotation of the ball screw shaft, since the opening end portion of the frame body containing the movable body forms a frame to provide a rigid body construction, the differential mechanism is neither twisted nor loosened. A trouble such that the frame of opening end portion of the frame body in which the movable body is contained opens undesirably to the outside is prevented by preventing the movable body from loosening or squeaking undesirably in the frame body. Therefore, the electric press apparatus can withstand long-term fixed point working.

In the case where the lid body that covers the outer wall surface of frame body of the differential mechanism so as to be slidable vertically is provided, a trouble such that the frame of opening end portion of the frame body in which the movable body is contained opens undesirably to the outside is further prevented, so that the electric press apparatus can withstand longer-term fixed point working.

### BRIEF DESCRIPTION OF THE DRAWINGS

FIG. 1 is a front view showing one example of an electric press apparatus in accordance with the present invention, in which a part of an essential portion is sectioned;

FIG. 2 is a front view showing one example of a differential mechanism used as a connecting mechanism;

FIG. 3 is a right side view of the differential mechanism shown in FIG. 2;

FIG. 4 is a plan view of the differential mechanism shown in FIG. 2;

FIG. 5 is a sectional view taken along the line A-A of FIG. 2;

FIG. 6 is a sectional view taken along the line E-E of FIG. 2;

FIG. 7 is an exaggerated sectional view illustrating the relationship between a movable body and a differential member;

FIG. 8 is a sectional view taken in the direction of the arrows along the line C-C of FIG. 7;

FIG. 9 is an exaggerated sectional view illustrating the relationship between a movable body and a differential member at the time when the differential member slides to the leftmost end;

FIG. 10 is a section view taken in the direction of the arrows along the line D-D of FIG. 9;

FIG. 11 is a front view showing another example of a differential mechanism used as a connecting mechanism;

FIG. 12 is a right side view of the differential mechanism shown in FIG. 11;

FIG. 13 is an explanatory view illustrating the movement of a contact point of a ball fitted in a ball groove in a nut member at the time when the nut member moves slightly in the axial direction;

FIG. 14 is a partially and longitudinally sectioned front view of a conventional electric press apparatus;

FIG. 15 is an enlarged front view showing a differential member and the neighborhood thereof; and

FIG. 16 is a sectional view taken along the line B-B of FIG. 15.

### DESCRIPTION OF SYMBOLS

1 . . . base plate

3 . . . support plate

9, 19 . . . differential mechanism

15 . . . ball screw shaft

17 . . . connecting mechanism

22 . . . motor (first motor)

28 . . . motor (second motor)

31 . . . frame body

32, 33 . . . frame side body

34, 35 . . . frame side body

91 . . . movable body

92 . . . frame body

94 . . . differential member

95 . . . screw shaft

97 . . . nut member

98 . . . lid body

### BEST MODE FOR CARRYING OUT THE INVENTION

An electric press apparatus in accordance with the present invention and a differential mechanism used for the electric press apparatus will be described.

### EXAMPLE 1

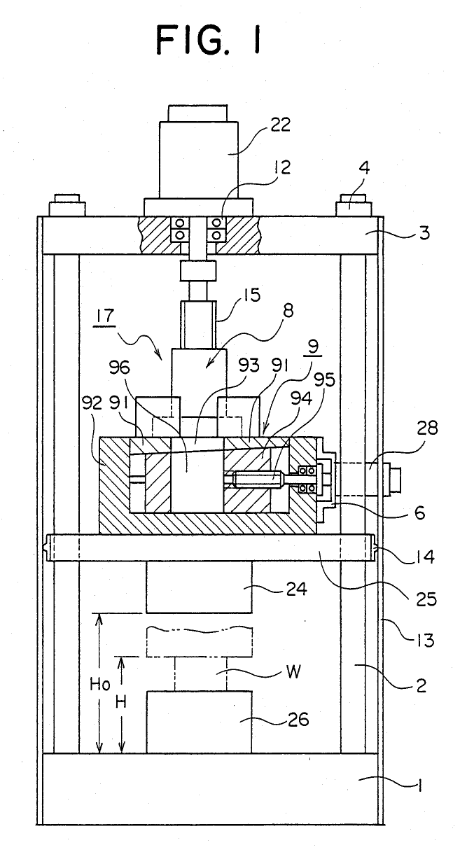

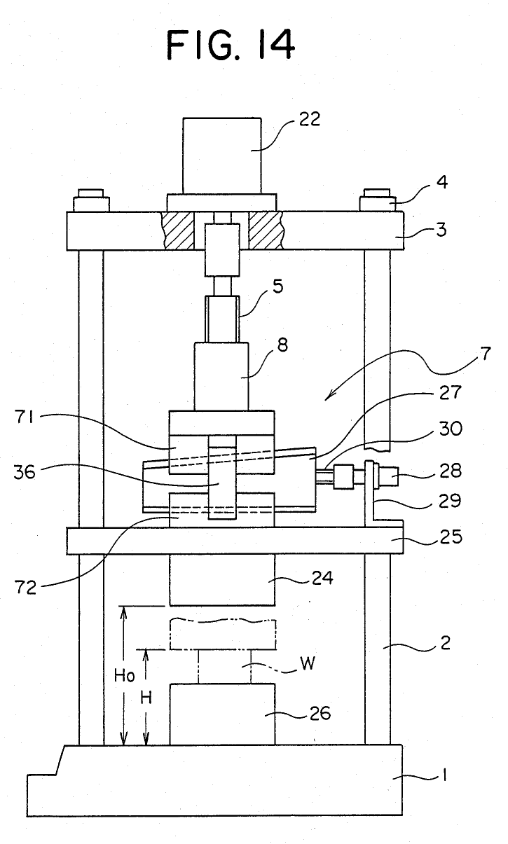

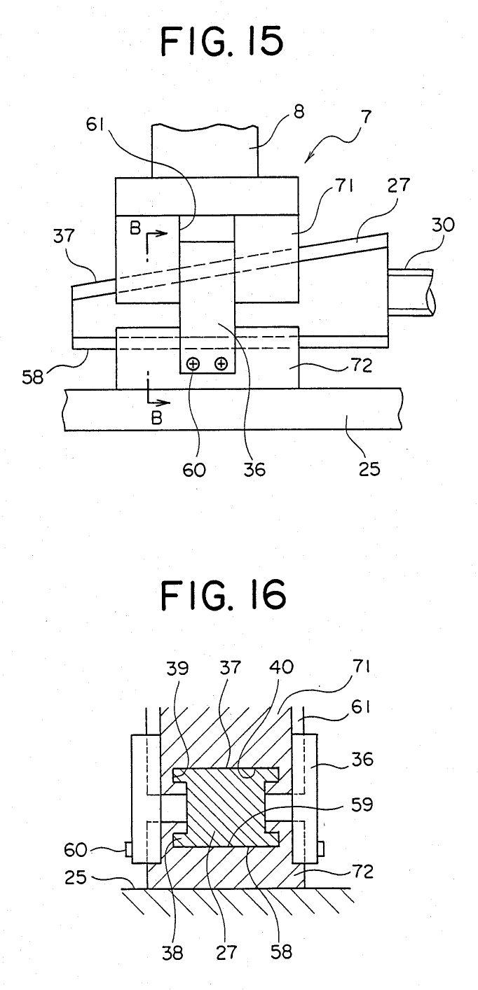

FIG. 1 is a front view showing one example of an electric press apparatus in accordance with the present invention, in which a part of an essential portion is sectioned. In this figure, the same reference numerals are applied to elements that are the same as those shown in FIG. 14.

In FIG. 1, reference numeral 1 denotes a base plate. The base plate 1 is formed into a rectangular flat plate shape, and columnar guide bars (guide bodies) 2 are erected at four corners thereof. To upper end portions of the guide bars 2, a support plate 3 formed into a rectangular flat plate shape is fixed via fastening members 4.

Reference numeral 25 denotes a slide plate. The slide plate 25 slidingly engages with the guide bars 2, and is provided so as to be slidable vertically. A pressing element 24 is fixed to a lower portion of the slide plate 25. Reference numeral 26 denotes a table. The table 26 is provided on the base plate 1 so that a workpiece W is mounted thereon.

On the support plate 3, an encoder-incorporated motor 22 is provided. To the shaft of the motor 22, a ball screw shaft 15 supported in parallel with the guide bars 2 is rotatably connected via a thrust bearing 12 provided in the support plate 3.

The support plate 3 and the slide plate 25 sliding freely the guide bars 2 have a construction such that they are connected to each other by a connecting mechanism 17. Specifically, the connecting mechanism 17 includes a nut member 8 threadedly engaging with the ball screw shaft 15, and also includes a differential mechanism 9 for slightly changing the contact position of the ball screw shaft 15 and the ball incorporated in the nut member 8. The lower end of the nut member 8 is fixed to the upper end of the differential mechanism 9, and the lower end of the differential mechanism 9 is fixed to the slide plate 25. The construction is such that the support plate 3 and the slide plate 25 are connected to each other by screw engagement of the ball screw shaft 15 pivotally supported by the support plate 3 with the nut member 8.

By the connecting mechanism 17 having such a construction, the slide plate 25 is raised or lowered by the normal rotation or the reverse rotation of the ball screw shaft 15 driven by the motor 2 capable of being rotated in the normal and reverse directions. Therefore, the slide plate 25 can be reciprocated in the vertical direction by the appropriate rotation control of the motor 22, by which a workpiece W mounted on the base plate 1 can be subjected to fixed point working as in the case explained with reference to FIG. 14.

For the above-described differential mechanism 9, a movable body 91 and a differential member 94 are contained in a rectangular parallelepipedic frame body 92 (the frame body 92 may be integral or may be made integral by assembling, and it is a rectangular parallelepiped having a shape such that the central portion thereof is substantially hollowed out) having a shape such that the central portion thereof is substantially hollowed out with a square frame shaped opening, which is adopted to form a rigid body, being provided at the top. The differential member 94 can be moved in the horizontal direction in FIG. 1, and the movable body 91 moves slightly in the vertical direction corresponding to the slight horizontal movement of the differential member 94.

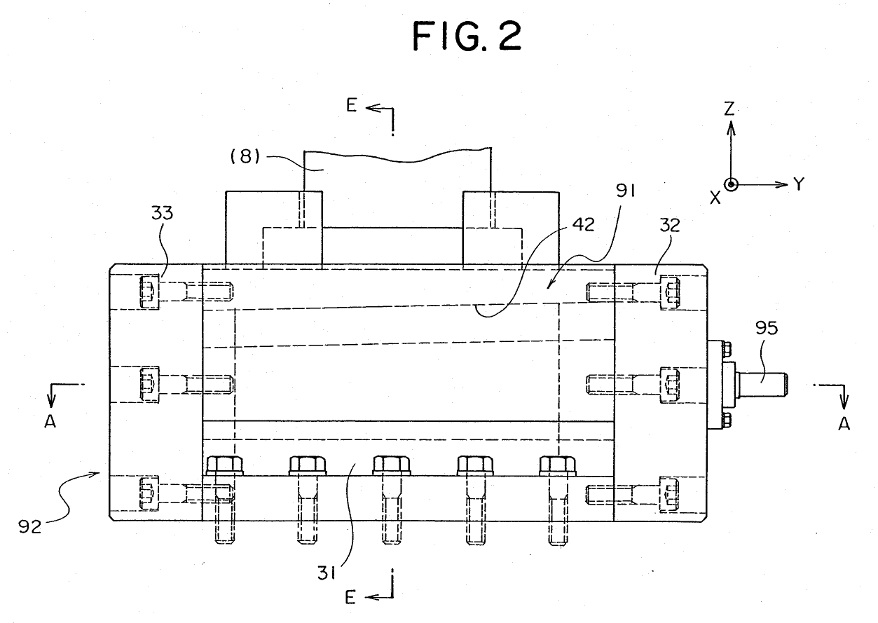

As shown in FIG. 1, the movable body 91 has an inclined surface portion the upper surface of which is horizontal and the lower surface of which is inclined, and has a hole 93, which allows the ball screw shaft 15 to pass through, in the central portion thereof. The movable body 91 is fitted so as to be slidable in the vertical direction, and is formed into a rectangular shape as viewed from the top. The differential member 94 has an inclined surface having the same angle of inclination as that of the movable body 91, and has a hole 96, which allows the ball screw shaft 15 to pass through, in the central portion thereof. By the horizontal movement of the differential member 94, the movable body 91 is moved in the vertical direction. A screw shaft 95 for moving the differential member 94 slightly in the horizontal direction is contained in the differential member 94. The constructions of the movable body 91 and the differential member 94 will be explained in detail later with reference to FIG. 2 and the following figures.

On the outside surface of the frame body 92, a motor 28 is installed via a support member 6, and the shaft of the motor 28 is connected to the screw shaft 95. The screw shaft 95 is pivotally supported by the frame body 92 via a bearing. Since both end surfaces of the bearing are held, the differential member 94 is restrained so as to be incapable of moving undesirably in the direction of the screw shaft 95.

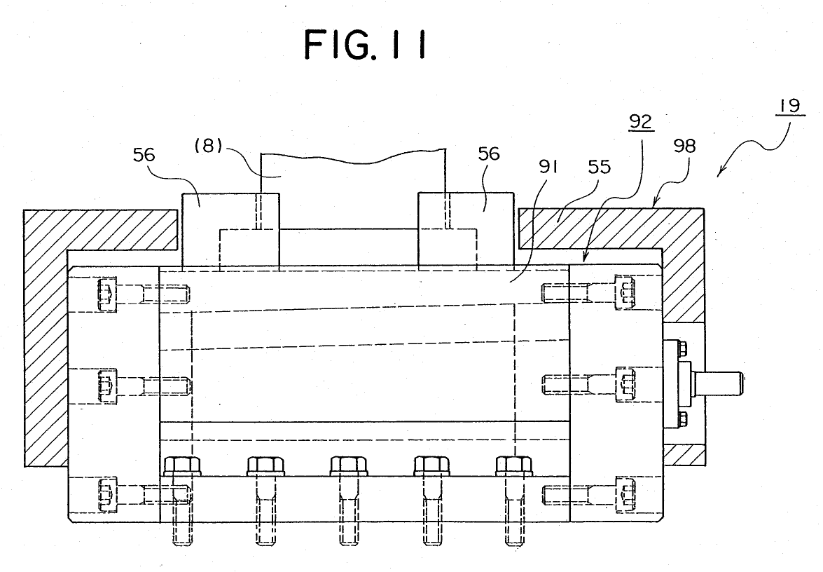

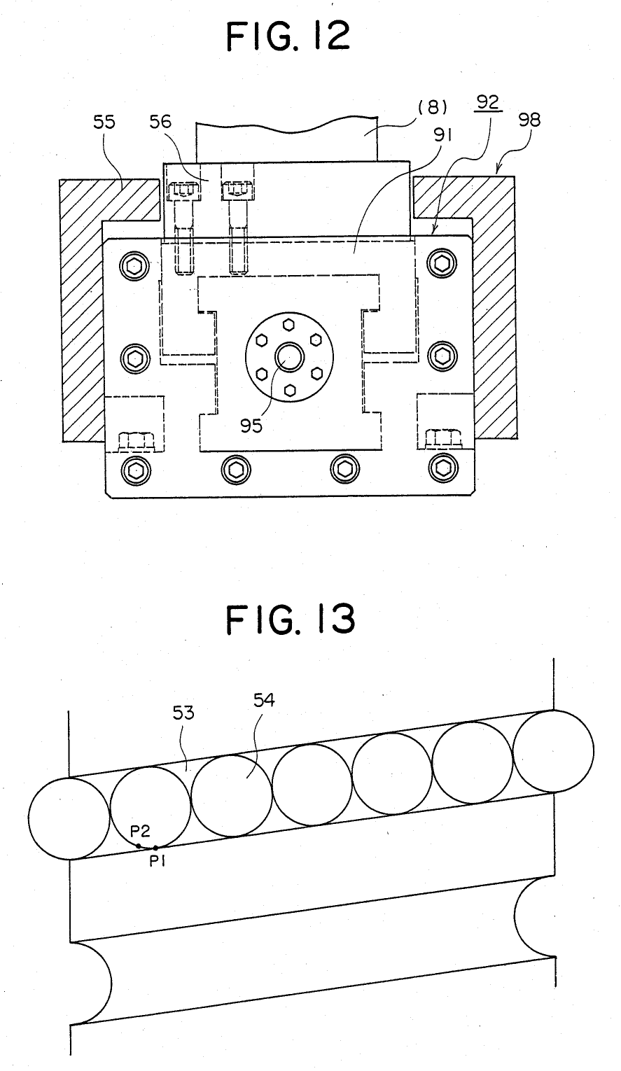

The frame body 92 is formed into a frame shape such that the central portion thereof is hollowed out so that the frame body 92 itself forms a rigid body as described above. Therefore, a trouble such that the upper end opening of the frame body 92 is undesirably opened to the outside by the collision with the upper end opening of the movable body 91 occurring during the time when press working is carried out for a long period of time is avoided. In order to securely prevent the danger of being opened to the outside, as described later, a lid body for covering the upper end opening of the frame body 92 (refer to FIGS. 11 and 12) may be provided.

Between the base plate 1 and the support plate 3, a pulse scale 13 for detecting the position of the slide plate 25, namely, the position of the pressing element 24 is installed along each of the four guide bars 2, and also a detecting portion 14 for reading the pulse scale 13 is provided at a corresponding position of the slide plate 25. Based on the detection signal of the position of the slide plate 25 obtained by the pulse scales 13 and the detecting portions 14, the fixed point working is carried out.

When the fixed point working reaches a preset number of cycles, or every time the fixed point working is performed, the operation of the motor 22 is stopped at the position of initial height Hₒ of the pressing element 24, and a preset number of pulse voltages are applied to the motor 28. Thereby, the motor 28 is rotated by a predetermined amount, and hence the differential member 94 is moved slightly in the horizontal direction via the screw shaft 95. By this movement of the differential member 94, the movable body 91 is moved in the vertical direction, and hence the pressing element 24 is displaced from the initial height Hₒ. This displacement is detected by the pulse scales 13 and the detecting portions 14, and to compensate this displacement, some voltage is applied to the motor 22, so that the initial height Hₒ of the pressing element 24 is always kept constant.

By the turning of the ball screw shaft 15 as the result of the above-described compensation, the relative position between the ball screw shaft 15 and the nut member 8 is changed, so that the relative position between a ball and a ball groove, which are formed for ball screw engagement, can be changed. Therefore, local wear of the ball and/or ball groove can be prevented while the fixed point working is secured, and the fixed point working can be performed continuously after that time.

### EXAMPLE 2

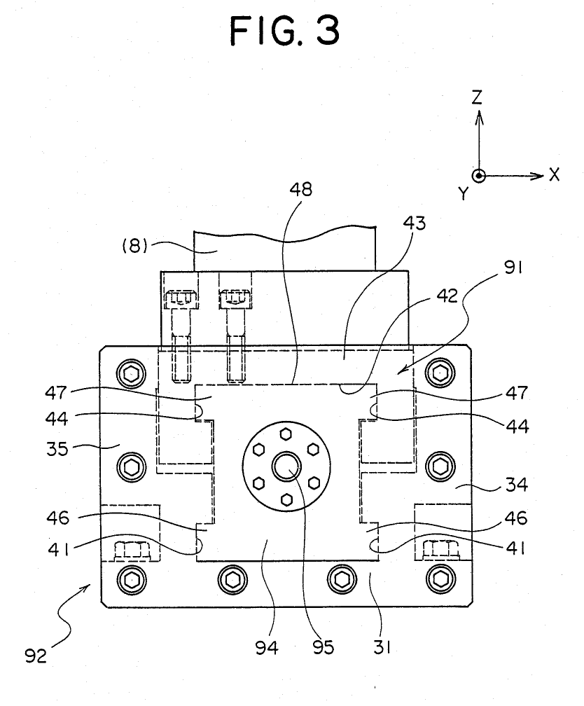

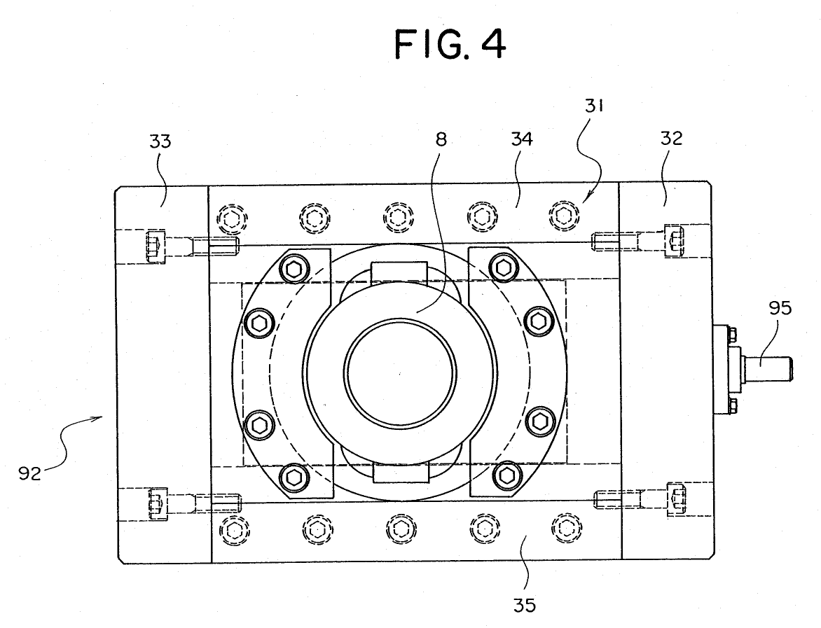

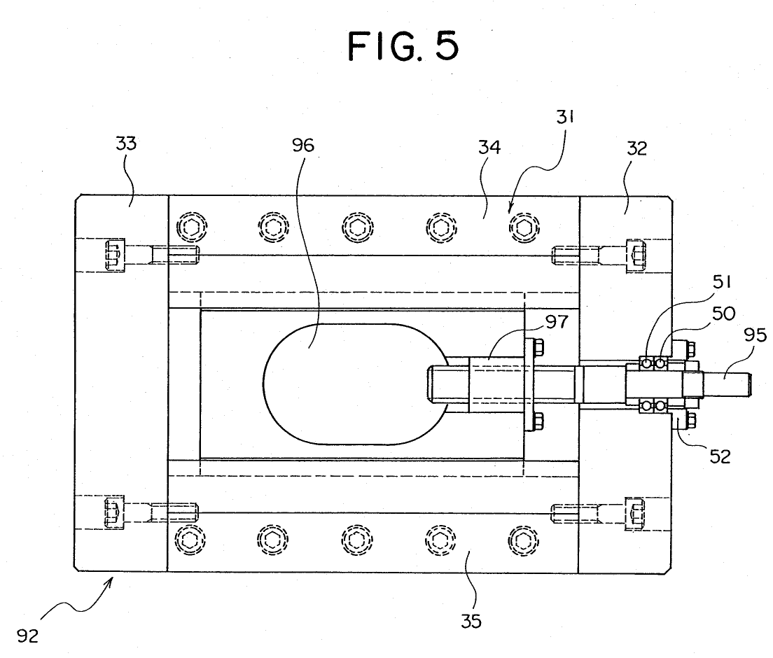

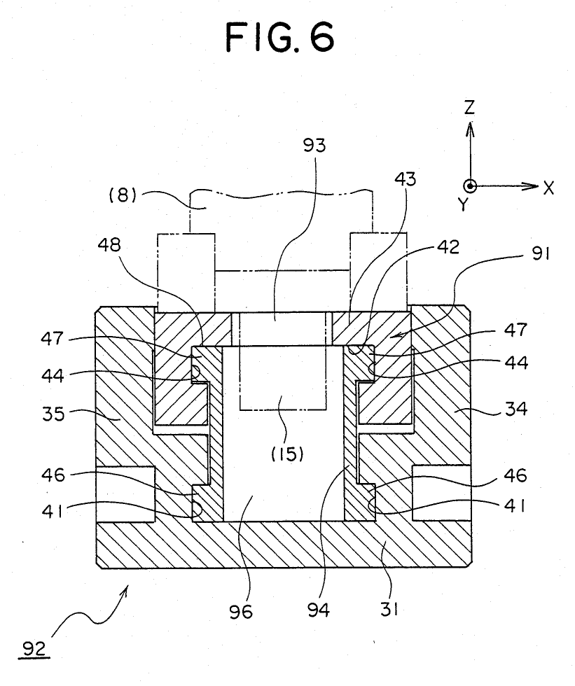

FIG. 2 is a front view showing one example of a differential mechanism used as a connecting mechanism, FIG. 3 is a right side view thereof, FIG. 4 is a plan view thereof, FIG. 5 is a sectional view taken along the line A-A of FIG. 2, and FIG. 6 is a sectional view taken along the line E-E of FIG. 2.

In FIGS. 2 to 6, the frame body 92 is made up of a bottomed frame body 31 having a substantially concave shape and two frame side bodies 32 and 33 fixed to both ends of the frame body 31. By the two frame side bodies 32 and 33 forming opposed surfaces and two frame side bodies 34 and 35 forming opposed surfaces of the frame body 31, the frame side bodies 32, 33, 34 and 35 forming an opening of the frame body 92 are integrated, and a rigid body is formed so that the opening at the upper end does not open toward the outside.

The frame body 92 formed by the opposed two sets of frame side bodies 32 and 33 and frame side bodies 34 and 35 is hollowed out so that the opposed inner wall surfaces of the frame side bodies 34 and 35 each are formed into a step shape of an upper part and a lower part. At the lower part of the frame body 31, namely, in the inner wall surface in the bottom surface portion of each of the opposed surfaces of the frame side bodies 34 and 35 hollowed out on the bottom surface side, a stripe of concave slide groove 41 is provided.

The movable body 91 has a rectangular shape so as to be fitted in the opening of the frame body 92, having an inverse C shaped longitudinal cross section. The movable body 91 has an upper plate portion 43 having an inclined surface portion 42 in which the top surface of the movable body 91 is horizontal and the back surface of the upper plate portion 43 is inclined, and on the back surface side of the upper plate portion 43, a stripe of concave slide groove 44 is formed along the inclined surface of the back surface of the upper plate portion 43. In the central portion of the movable body 91, the hole 93 (refer to FIG. 1) for allowing the ball screw shaft 15 to pass through is provided, and on the surface of the upper plate portion 43 is fixed the nut member 8. The movable body 91 is fitted so as to be slidable in the axial direction of the nut member 8 in the opening of the frame 92.

The differential member 94 has a wedge shape fitted so as to be slidable in the frame body 92, having a substantially I shaped longitudinal cross section as shown in FIG. 3. The differential member 94 is a member that plays a role of sliding the movable body 91 in the axial direction of the nut member 8 by means of the movement of the differential member 94. Specifically, the differential member 94 has a guide engagement portion 46, which slidingly engages with the concave slide groove 41 formed in the frame body 92, in the lower end portion. Also, the differential member 94 has, in the upper end portion, an inclined surface corresponding to the inclined surface of the back surface of the upper plate portion 43 of the movable body 91, and has a guide engagement portion 47 which slidingly engages with the concave slide groove 44 formed on the back surface side of the movable body 91. The differential member 94 has an inclined upper surface portion 48, and has a horizontal lower surface portion. The inclined upper surface portion has the same angle of inclination as that of the inclined surface portion 42 provided on the back of the upper plate portion 43 of the movable body 91. In the central portion of the differential member 94, the hole 96 (refer to FIG. 1) for allowing the ball screw shaft 15 to pass through is provided.

On the frame side body 32 of the frame body 92, the screw shaft 95 is rotatably provided via a bearing 50, and external threads cut on one side of the screw shaft 95 are engaged with an internally threaded hole in a nut member 97 provided in the differential member 94. The other end side of the screw shaft 95 projects from the frame side body 32 and is connected to the motor 28 shown in FIG. 1. The bearing 50 for pivotally supporting the screw shaft 95 is formed so that the outside diameter portion thereof is fixed to the frame side body 32 by a step portion 51 provided in the frame side body 32 and a bearing fixing plate 52. By the internal construction of the bearing 50 itself and the bearing fixing construction using the step portion 51 provided in the frame side body 32 and the bearing fixing plate 52, undesirable movement of the differential member 94 in the axial direction of the screw shaft 95 is restrained.

When orthogonal three axes such that the axial direction of the nut member 8 is taken as Z, the axial direction of the screw shaft 95 is taken as Y, and the direction perpendicular to the axial direction of the screw shaft 95 is taken as X are introduced as shown in FIGS. 2, 3 and 6, the differential member 94 is restrained in the X-axis direction and the Z-axis direction by the two slide grooves 41 and 44 provided in the frame body 92 and the two guide engagement portions 46 and 47 of the differential member 94, which are guided by the slide groove 41 and the slide groove 44, but can be moved freely in the Y-axis direction. Also, the movable body 91 is restrained in the X-axis direction and the Y-axis direction by four side wall surfaces of the upper plate portion 43 of the movable body 91 and inner wall engagement surfaces of the four frame side bodies of the upper end opening, and by the two slide grooves 44 provided in the movable body 91 and the two guide engagement portions 47 of the differential member 94, which are guided by the slide grooves 44, but can be moved freely in the Z-axis direction.

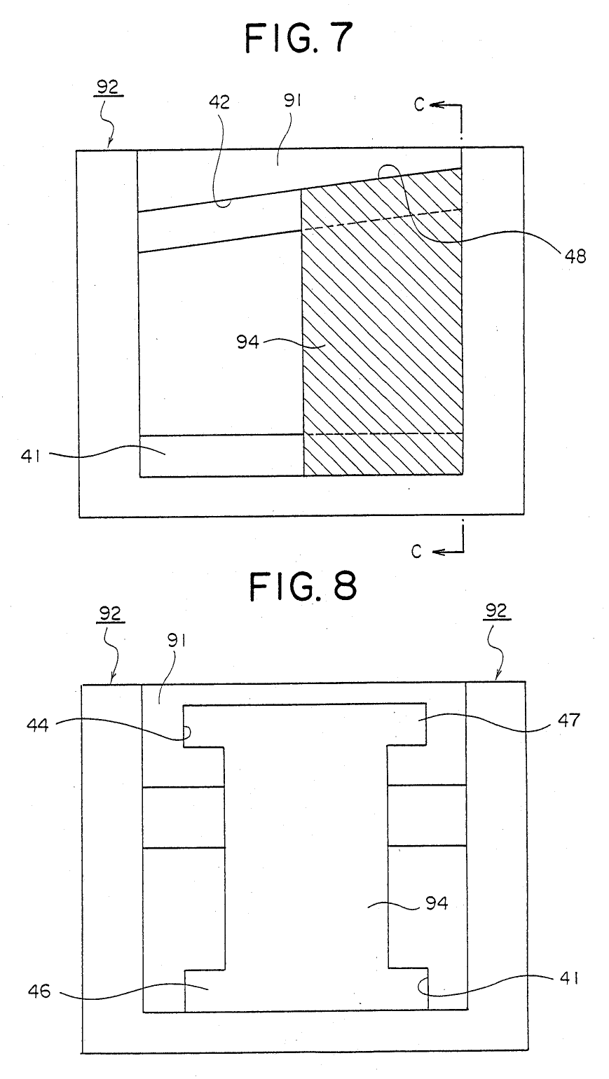

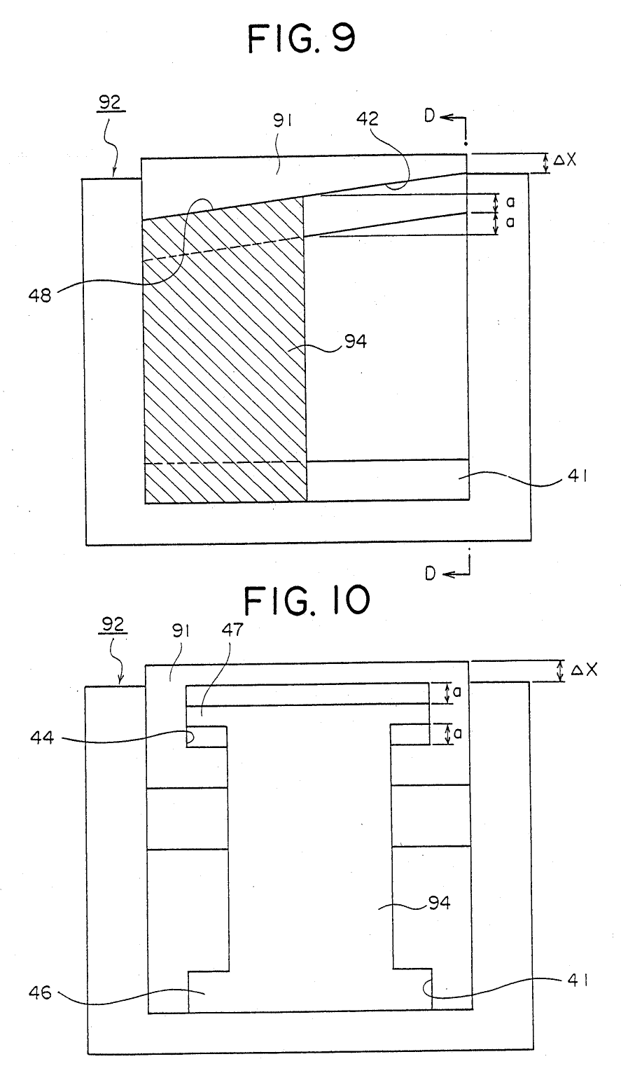

In the differential mechanism 9 having such a restraining construction, in which the movable body 91 and the differential member 94 are incorporated in a hollowed-out frame body 92, FIG. 7 is an exaggerated sectional view (attention should be paid to the exaggeration of angle of inclination in the hatched portion) illustrating the relationship between the movable body and the differential member. In FIG. 7, the differential member 94 is positioned at the rightmost end. FIG. 8 is a view taken in the direction of the arrows along the line C-C of FIG. 7. The differential member 94 shown in FIG. 8 is moved a predetermined short distance in the Y-axis direction via the screw shaft 95 for each preset turn of the motor 28. The differential member 94 is slidingly moved by the inclined surface portion 42 provided on the back surface of the upper plate portion 43 each time the differential member 94 is moved slightly, and hence the movable body 91 is pushed up by a small height ΔH in the Z-axis direction each time. When the motor 28 finishes the rotation in the same direction of preset turns, as shown in FIG. 9, the differential member 94 arrives at the leftmost end. FIG. 9 is an exaggerated sectional view (attention should be paid to the exaggeration of angle of inclination in the hatched portion) illustrating the relationship between the movable body and the differential member 6 at the time when the differential member 94 slides to the leftmost end. FIG. 10 is a view taken in the direction of the arrows along the line D-D of FIG. 9. As shown in FIG. 10, the upper surface of the movable body 91 rises through ΔX from the upper end opening. Thereby, the nut member 8 fixed to the movable body 91 can also be raised through ΔX.

In order to perform the fixed point working in the state in which the movable body 91 is raised through ΔX, the height Hₒ is determined by the measurement using the pulse scales 13 and the detecting portions 14 shown in FIG. 1 and the motor 22 shown in FIG. 1 is rotated to eliminate the increase ΔX of height. At this time, as shown in FIG. 13, balls 54 fitted in a ball groove 53 in the nut member 8 rotate slightly in the ball groove 53. Specifically, at the time of pressing, a contact point P1 of the ball 54 fitted in the ball groove 53 shifts, the contact point of the ball 54 becoming P2 (P2≠PI), so that pressing is not performed in a state in which the contact point between the ball 54 and the ball groove 53 is at the same position.

That is to say, by using the above-described differential mechanism 9, the differential member 94 of the differential mechanism 9 is moved a short distance in the Y-axis direction by the motor 28, and hence the movable body 91 is slightly moved in the Z-axis direction to eliminate the displacement in the Z-axis direction, by which the relative position between the ball 54 and the ball groove 53, which are formed for ball screw engagement, is changed to prevent pressing from being performed at the same position. In the case of the present invention, a trouble such that the movable body 91 loosens undesirably in the frame body 31 and the vertical position of the movable body 91 changes undesirably at the time of press working is avoided.

Specifically, in the slide grooves 41, 41 provided in the frame side bodies 34 and 35 of the frame body 92, the whole of the guide engagement portions 46, 46 of the differential member 94 is provided so as to be slidable in the Y-axis direction. Therefore, the differential member 94 is restrained in the X-axis and Z-axis directions with respect to the frame body 92 to prevent looseness. Although the differential member 94 can be slid in the Y-axis direction, after the differential member 94 has been slidingly moved a predetermined amount in the Y-axis direction by the motor 28 and has been set, the screw shaft 95 provided on the differential member 94 prevents undesirable looseness of the differential member 94 in the Y-axis direction in a location of bearing 50 shown in FIG. 5. That is to say, the bearing 50 is prohibited from moving undesirably in the Y-axis direction with respect to the frame side body 32 by the step portion 51 and the bearing fixing plate 52 of the frame side body 32. The screw shaft 95 of the differential member 94 is prevented from moving undesirably in the Y-axis direction by the bearing 50.

Further, the slide groove 44 provided in the movable body 91 engagedly holds the guide engagement portion 47 formed on the differential member 94, and holds the guide engagement portion 47 so that it is slidable only in the Y-axis direction. Still further, four side surfaces of the movable body 91 having a rectangular shape as viewed from the top are engaged with the frame side bodies 32, 33, 34 and 35 of the frame body 92 so as to be slidable in the Z-axis direction. Therefore, the movable body 91 is restrained in the X-axis and Y-axis directions with respect to the frame body 92 unless the frame side bodies 32,33, 34 and 35 of the frame body 92 do not loosen undesirably and the differential member 94 does not loosen with respect to the frame body 92, and is restrained even in the Z-axis direction with respect to the frame body 92 together with the differential member 94. It is a matter of course that the turning around the X-axis, the turning around the Y-axis, and the turning around the Z-axis of the movable body 91 are also restrained.

Still further, since the frame side bodies 32, 33, 34 and 35 of the frame body 92 are formed into a rigid body (needless to say, even if they are formed into a rigid body by bolting), not only the movement in the X-axis, Y-axis, and Z-axis directions of the movable body 91 but also the turning around the X-axis, Y-axis, and Z-axis thereof is restrained.

In FIG. 2, the inclination of the back surface of the upper plate portion of the movable body 91 and the inclination of a stripe of slide grooves 44, 44 formed on both sides of the back surface, the inclination of the upper surface of the differential member 94, the inclination of the guide engagement portions 46, 46 in both side portions of the differential member 94 cannot be shown clearly (because the angle of inclination is small). Therefore, to show this point clearly, the inclinations are shown exaggeratedly in FIGS. 7 to 10.

In the case of the configuration shown in FIG. 2, the slide grooves 44, 44 and the guide engagement portions 46, 46 must have the same angle of inclination as the inclination of the back surface of the upper plate of the movable body 91 and the inclination of the upper surface of the differential member 94 corresponding to this (although not shown clearly in FIG. 2).

### EXAMPLE 3

FIG. 11 is a front view showing another example of a differential mechanism used as a connecting mechanism, and FIG. 12 is a right side view of the differential mechanism shown in FIG. 11.

In FIGS. 11 and 12, a differential mechanism 19 differs from the differential member 9 explained with reference to FIGS. 2 to 5 in that a lid body 98 is further provided to cover the upper surface of outer wall surface of the frame body 92 of the differential mechanism 9.

The lid body 98 connects the frame side bodies 32 and 33 of the frame body to each other, and also connects the frame side bodies 34 and 35 of the frame body to each other. The purpose for this is to prevent a clearance between the opposed frame side bodies 32 and 33 from increasing and a clearance between the opposed frame side bodies 34 and 35 from increasing. Needless to say, the four frame side bodies 32, 33, 34 and 35 may be fixed together.

### EXAMPLE 4

In the above-described explanation, the movable body 91 is moved vertically by the movement of the differential member 94 of a shape having the inclined surface portion the lower surface of which is horizontal and the upper surface of which is inclined. However, in moving the movable body 91 vertically, the differential mechanism 9 having a different construction depending on the position of the differential member 94 at which the inclined surface portion is formed can be constructed. The following is a description of this mode.

Mode (1) The differential member 94 having a construction characterized by including the movable body 91 which has the upper plate portion 43 having horizontal surfaces on the top surface and the back surface thereof, a stripe of slide groove 44 formed on the back surface side of the upper plate portion 43, has the hole 93, which allows the ball screw shaft 15 to pass through, in the central portion, is fitted in the opening of the frame body 92, and the nut member 8 is fixed to the surface thereof, and the differential member 94 which has a guide engagement portion 46, which slidingly engages with the slide groove 41 formed in the frame body 92, in the lower end portion, has a guide engagement portion 47, which slidingly engages with the slide groove 44 formed on the back surface side of the movable body 91, in the upper end portion; has an upper surface portion being horizontal and a lower surface portion being inclined; has the hole 96, which allows the ball screw shaft 15 to pass through, in the central portion; and has a wedge shape fitted so as to be slidable in the frame body 92, wherein the slide groove 44 formed on the back surface side of the upper plate portion 43 of the movable body 91 has a horizontal surface along the horizontal surface of the back surface of the upper plate portion 43, and the surface of the slide groove 41 of the frame body 92 and the guide engagement portion 46 formed on the differential member 94 have an inclined surface corresponding to the inclined surface of the lower surface of the differential member 94.

### EXAMPLE 5

In the electric press apparatus including the differential mechanism 9 having a construction of mode (1) as well, it is a matter of course that as shown in FIGS. 11 and 12, the lid body 98 may be provided so as to cover the outer wall surface of the frame body 92 including the differential mechanism 9 having a construction of mode (1) in such a manner of being slidable vertically.

### INDUSTRIAL APPLICABILITY

According to the present invention, the differential mechanism is neither twisted nor loosened. Also, a trouble such that the frame of opening end portion of the frame body in which the movable body is contained opens undesirably to the outside is prevented by preventing the movable body from loosening or squeaking undesirably in the frame body. Therefore, an electric press apparatus that withstands long-term fixed point working can be provided. That is to say, the occurrence of undesirable flaw that may be induced locally in the engagement of the ball screw shaft with the nut portion used in the electric press apparatus can be prevented, so that the electric press apparatus can withstand long-term fixed point working.

1. An electric press apparatus comprising:
a base plate formed into a flat plate shape;
a plurality of guide bodies provided so that one end portions thereof intersect at right angles with the base plate;
a flat plate shaped support plate provided at the other end portions of the guide bodies so as to intersect at right angles with the guide bodies;
a slide plate provided so as to be slidingly moved between the base plate and the support plate by being guided by the guide bodies;
a first motor for driving the slide plate slidably with respect to the guide bodies;
a ball screw shaft which is connected to the output shaft of the first motor and is pivotally supported so as to be moved in parallel with the guide bodies with respect to the support plate;
a nut member threadedly engaged with the ball screw shaft; and
a differential mechanism, the upper end of which is fixed to the nut member and the lower end of which is fixed to the slide plate, for slightly changing the contact position between the ball screw shaft and balls incorporated in the nut member,
the slide plate being moved vertically by the normal and reverse rotations of the ball screw shaft driven by the first motor, whereby a workpiece mounted on the base plate is subjected to fixed point working, characterized in that
the differential mechanism comprises:
a frame body in which
an opening of four inner wall surfaces corresponding to an opening portion hollowed out substantially into a rectangular parallelepipedic shape is provided in the upper surface,
a stripe of slide groove is provided at a bottom surface portion in inner wall surface of one set of opposed surfaces of two sets of opposed surfaces,
and the rectangular parallelepipedic opening portion forms a rigid body;
a movable body which
has an upper plate portion having an inclined surface portion the top surface of which is horizontal and the back surface of which is inclined,
a stripe of slide groove formed on the back surface side of the upper plate portion,
has a hole, which allows the ball screw shaft to pass through, in the central portion,
is fitted in the opening of the frame body,
and the nut member is fixed to the surface thereof;
a differential member which
has a first guide engagement portion, which slidingly engages with the slide groove formed in the frame body, in the lower end portion,
has a second guide engagement portion, which slidingly engages with the slide groove formed on the back surface side of the movable body, in the upper end portion,
has a lower surface portion being horizontal and an upper surface portion being inclined,
has a hole, which allows the ball screw shaft to pass through, in the central portion,
and has a wedge shape fitted so as to be slidable in the frame body;
a screw shaft for moving the differential member in the horizontal direction; and
a second motor for moving the differential member in the horizontal direction via the screw shaft of the differential mechanism.

2. The electric press apparatus in accordance with claim 1, wherein the slide groove formed on the back surface side of the upper plate portion of the movable body has a surface inclined along the inclined surface of the back surface of the upper plate portion.

3. The electric press apparatus in accordance with claim 2, wherein the second guide engagement portion formed on the differential member has a surface inclined corresponding to the inclined surface of the back surface of the upper plate portion of the movable body.

4. The electric press apparatus in accordance with claim 1, further comprising a lid body for connecting opposed surfaces to each other, said lid body is provided between two sets of opposed surfaces of the four inner wall surfaces of the frame body.

5. An electric press apparatus comprising:
a base plate formed into a flat plate shape;
a plurality of guide bodies provided so that one end portions thereof intersect at right angles with the base plate;
a flat plate shaped support plate provided at the other end portions of the guide bodies so as to intersect at right angles with the guide bodies;
a slide plate provided so as to be slidingly moved between the base plate and the support plate by being guided by the guide bodies;
a first motor for driving the slide plate slidably with respect to the guide bodies;
a ball screw shaft which is connected to the output shaft of the first motor and is pivotally supported so as to be moved in parallel with the guide bodies with respect to the support plate;
a nut member threadedly engaged with the ball screw shaft; and
a differential mechanism, the upper end of which is fixed to the nut member and the lower end of which is fixed to the slide plate, for slightly changing the contact position between the ball screw shaft and balls incorporated in the nut member,
the slide plate being moved vertically by the normal and reverse rotations of the ball screw shaft driven by the first motor, whereby a workpiece mounted on the base plate is subjected to fixed point working, characterized in that
the differential mechanism comprises:
a frame body in which
an opening of four inner wall surfaces corresponding to an opening portion hollowed out substantially into a rectangular parallelepipedic shape is provided in the upper surface,
a stripe of slide groove is provided at a bottom surface portion in inner wall surface of one set of opposed surfaces of two sets of opposed surfaces,
and the rectangular parallelepipedic opening portion forms a rigid body;
a movable body which
has an upper plate portion having horizontal surfaces on the top surface and the back surface thereof,
a stripe of slide groove formed on the back surface side of the upper plate portion,
has a hole, which allows the ball screw shaft to pass through, in the central portion,
is fitted in the opening of the frame body,
and the nut member is fixed to the surface thereof;
a differential member which
has a first guide engagement portion, which slidingly engages with the slide groove formed in the frame body, in the lower end portion,
has a second guide engagement portion, which slidingly engages with the slide groove formed on the back surface side of the movable body, in the upper end portion,
has an upper surface portion being horizontal and a lower surface portion being inclined,
has a hole, which allows the ball screw shaft to pass through, in the central portion,
and has a wedge shape fitted so as to be slidable in the frame body;
a screw shaft for moving the differential member in the horizontal direction; and
a second motor for moving the differential member in the horizontal direction via the screw shaft of the differential mechanism.

6. The electric press apparatus in accordance with claim 5, wherein the slide groove formed on the back surface side of the upper plate portion of the movable body has a horizontal surface along the back surface of the upper plate portion.

7. The electric press apparatus in accordance with claim 6, wherein the surface of the slide groove of the frame body has an inclined surface along the inclined surface of the lower surface of the differential member, and the first guide engagement portion formed on the differential member has a surface inclined corresponding to the inclined surface of the lower surface of the differential member.

8. The electric press apparatus in accordance with claim 5, further comprising a lid body for connecting opposed surfaces to each other, said lid body is provided between two sets of opposed surfaces of the four inner wall surfaces of the frame body.

9. A differential mechanism used in an electric press apparatus comprising:
a base plate formed into a flat plate shape;
a plurality of guide bodies provided so that one end portions thereof intersect at right angles with the base plate;
a flat plate shaped support plate provided at the other end portions of the guide bodies so as to intersect at right angles with the guide bodies;
a slide plate provided so as to be slidingly moved between the base plate and the support plate by being guided by the guide bodies;
a first motor for driving the slide plate slidably with respect to the guide bodies;
a ball screw shaft which is connected to the output shaft of the first motor and is pivotally supported so as to be moved in parallel with the guide bodies with respect to the support plate;
a nut member threadedly engaged with the ball screw shaft; and
a differential mechanism, the upper end of which is fixed to the nut member and the lower end of which is fixed to the slide plate, for slightly changing the contact position between the ball screw shaft and balls incorporated in the nut member,
the slide plate being moved vertically by the normal and reverse rotations of the ball screw shaft driven by the first motor, whereby a workpiece mounted on the base plate is subjected to fixed point working, characterized in that
the differential mechanism comprises:
a frame body in which
an opening of four inner wall surfaces corresponding to an opening portion hollowed out substantially into a rectangular parallelepipedic shape is provided in the upper surface,
a stripe of slide groove is provided at a bottom surface portion in inner wall surface of one set of opposed surfaces of two sets of opposed surfaces,
and the rectangular parallelepipedic opening portion forms a rigid body;
a movable body which
has an upper plate portion having an inclined surface portion the top surface of which is horizontal and the back surface of which is inclined,
a stripe of slide groove formed on the back surface side of the upper plate portion,
has a hole, which allows the ball screw shaft to pass through, in the central portion,
is fitted in the opening of the frame body,
and the nut member is fixed to the surface thereof;
a differential member which
has a first guide engagement portion, which slidingly engages with the slide groove formed in the frame body, in the lower end portion,
has a second guide engagement portion, which slidingly engages with the slide groove formed on the back surface side of the movable body, in the upper end portion,
has a lower surface portion being horizontal and an upper surface portion being inclined,
has a hole, which allows the ball screw shaft to pass through, in the central portion,
and has a wedge shape fitted so as to be slidable in the frame body;
a screw shaft for moving the differential member in the horizontal direction; and
a second motor for moving the differential member in the horizontal direction via the screw shaft of the differential mechanism.

10. The differential mechanism according to claim 9, wherein the slide groove formed on the back surface side of the upper plate portion of the movable body has a surface inclined along the inclined surface of the back surface of the upper plate portion.

11. The differential mechanism in accordance with claim 10, wherein the second guide engagement portion formed on the differential member has a surface inclined corresponding to the inclined surface of the back surface of the upper plate portion of the movable body.

12. The differential mechanism in accordance with claim 9, further comprising a lid body for connecting opposed surfaces to each other, said lid body is provided between two sets of opposed surfaces of the four inner wall surfaces of the frame body.

13. A differential mechanism used in an electric press apparatus comprising:
a base plate formed into a flat plate shape;
a plurality of guide bodies provided so that one end portions thereof intersect at right angles with the base plate;
a flat plate shaped support plate provided at the other end portions of the guide bodies so as to intersect at right angles with the guide bodies;
a slide plate provided so as to be slidingly moved between the base plate and the support plate by being guided by the guide bodies;
a first motor for driving the slide plate slidably with respect to the guide bodies;
a ball screw shaft which is connected to the output shaft of the first motor and is pivotally supported so as to be moved in parallel with the guide bodies with respect to the support plate;
a nut member threadedly engaged with the ball screw shaft; and
a differential mechanism, the upper end of which is fixed to the nut member and the lower end of which is fixed to the slide plate, for slightly changing the contact position between the ball screw shaft and balls incorporated in the nut member,
the slide plate being moved vertically by the normal and reverse rotations of the ball screw shaft driven by the first motor, whereby a workpiece mounted on the base plate is subjected to fixed point working, characterized in that
the differential mechanism comprises:
a frame body in which
an opening of four inner wall surfaces corresponding to an opening portion hollowed out substantially into a rectangular parallelepipedic shape is provided in the upper surface,
a stripe of slide groove is provided at a bottom surface portion in inner wall surface of one set of opposed surfaces of two sets of opposed surfaces,
and the rectangular parallelepipedic opening portion forms a rigid body;
a movable body which
has an upper plate portion having horizontal surfaces on the top surface and the back surface thereof,
a stripe of slide groove formed on the back surface side of the upper plate portion,
has a hole, which allows the ball screw shaft to pass through, in the central portion,
is fitted in the opening of the frame body,
and the nut member is fixed to the surface thereof;
a differential member which
has a first guide engagement portion, which slidingly engages with the slide groove formed in the frame body, in the lower end portion,
has a second guide engagement portion, which slidingly engages with the slide groove formed on the back surface side of the movable body, in the upper end portion,
has an upper surface portion being horizontal and a lower surface portion being inclined,
has a hole, which allows the ball screw shaft to pass through, in the central portion,
and has a wedge shape fitted so as to be slidable in the frame body;
a screw shaft for moving the differential member in the horizontal direction; and
a second motor for moving the differential member in the horizontal direction via the screw shaft of the differential mechanism.

14. The differential mechanism in accordance with claim 13, wherein the slide groove formed on the back surface side of the upper plate portion of the movable body has a horizontal surface along the back surface of the upper plate portion.

15. The differential mechanism in accordance with claim 14, wherein the surface of the slide groove of the frame body has an inclined surface along the inclined surface of the lower surface of the differential member, and the first guide engagement portion formed on the differential member has a surface inclined corresponding to the inclined surface of the lower surface of the differential member.

16. The differential mechanism in accordance with claim 13, further comprising a lid body for connecting opposed surfaces to each other, said lid body is provided between two sets of opposed surfaces of the four inner wall surfaces of the frame body.
